(19) United States
(12) Patent Application Publication
(10) Pub. No.: US 2025/0023934 A1
(43) Pub. Date: Jan. 16, 2025

(54) SYSTEMS AND METHODS FOR MANAGING TURN-BASED COMMUNICATIONS

(71) Applicant: Hill-Rom Services, Inc., Batesville, IN (US)

(72) Inventors: Joel Centelles Martin, Montornès del Vallès (ES); Kurt Bessel, Mexico, NY (US)

(73) Assignee: Hill-Rom Services, Inc., Batesville, IN (US)

(21) Appl. No.: 18/771,359

(22) Filed: Jul. 12, 2024

Related U.S. Application Data
(60) Provisional application No. 63/526,497, filed on Jul. 13, 2023.

(51) Int. Cl. H04L 65/4061; H04L 51/046; H04W 72/0453

(52) U.S. Cl. CPC H04L 65/4061; H04L 51/046; H04W 72/0453

(57) ABSTRACT

A system for managing turn-based audio communications includes a user identity that is assignable to a communication device of a plurality of communication devices. The communication device is configured to communicate the turn-based audio communications on at least one channel. The system also includes a monitoring module that monitors at least one communication attribute of the at least one channel. Control circuitry is communicatively coupled with the monitoring module and is configured to determine a modification for the at least one channel based on the at least one communication attribute and adjust a messaging feature of the at least one channel in response to the modification. The messaging feature includes at least one of a timer for push-to-talk (PTT) messaging, a membership of the user identity to the at least one channel, and a priority level for the at least one channel.

### CROSS-REFERENCE TO RELATED APPLICATION

This application claims priority to and the benefit under 35 U.S.C. § 119 (e) of U.S. Provisional Application No. 63/526,497, filed on Jul. 13, 2023, entitled “SYSTEMS AND METHODS FOR MANAGING TURN-BASED COMMUNICATIONS,” the disclosure of which is hereby incorporated herein by reference in its entirety.

### FIELD OF THE DISCLOSURE

The present disclosure generally relates to systems and methods for managing turn-based communications and, more particularly, to dynamic adjustment to properties of channels on a push-to-talk network.

### SUMMARY OF THE DISCLOSURE

According to one aspect of the present disclosure, a system for managing turn-based audio communications includes a user identity that is assignable to a communication device of a plurality of communication devices. The communication device is configured to communicate the turn-based audio communications on at least one channel. The system also includes a monitoring module that monitors at least one communication attribute of the at least one channel. Control circuitry is communicatively coupled with the monitoring module and is configured to determine a modification for the at least one channel based on the at least one communication attribute and adjust a messaging feature of the at least one channel in response to the modification. The messaging feature includes at least one of a timer for push-to-talk (PTT) messaging, a membership of the user identity to the at least one channel, and a priority level for the at least one channel.

According to another aspect of the present disclosure, a system for managing turn-based audio communications for use with at least one communication device configured to communicate on at least one channel includes at least one user identity that is assignable to the at least one communication device. The at least one user identity has membership on a common channel of the at least one channel. The system also includes a monitoring module that monitors at least one communication attribute of the common channel. Control circuitry is communicatively coupled with the monitoring module. The control circuitry is configured to detect interaction within the membership in a session on the common channel, classify the interaction based on participation of the at least one user identity in the session, determine a modification for the common channel based on classification of the interaction, and adjust the membership of the common channel in response to the modification.

According to yet another aspect of the present disclosure, a method for managing turn-based audio communications includes monitoring at least one communication attribute of at least one channel over which the turn-based audio communications are exchanged among a plurality of communication devices, determining a modification for the at least one channel based on the at least one communication attribute, and then adjusting a messaging feature of the at least one channel in response to the modification. The messaging feature includes at least one of a timer for push-to-talk (PTT) messaging, a membership of a user identity to the at least one channel, and a priority level for the at least one channel.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front view of an exemplary wearable communication device;

FIG. 2 is a block diagram of a communication system for the wearable communication device of FIG. 1;

FIG. 3 is a schematic diagram of a system for managing turn-based communications incorporating a plurality of the exemplary wearable communication devices shown in FIG. 1;

FIG. 4 is an exemplary process for managing transmission time on a common channel of a system for managing turn-based communications;

FIG. 5 is an exemplary process for managing a team on a common channel of a system for managing turn-based communications; and

FIG. 6 is an exemplary process for managing priority levels for multiple channels of a system for managing turn-based communications.

### DETAILED DESCRIPTION

The present illustrated embodiments reside primarily in combinations of method steps and apparatus components related to a systems and methods for managing turn-based communications. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

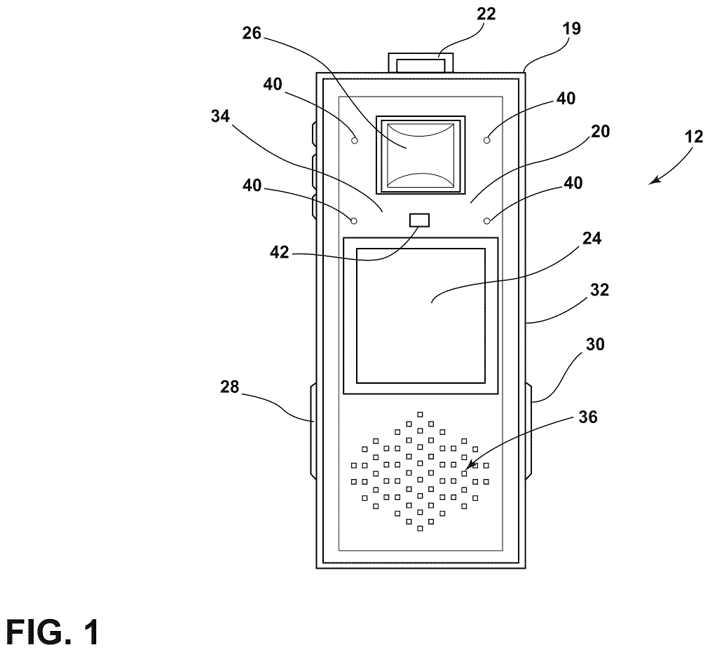

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-6, reference numeral 10 generally designates a system for managing turn-based audio communications. The system 10 includes a plurality of communication devices 12 each assigned to a plurality of user identities 14a-14d and operable with the turn-based audio communications on at least one channel 16a-16c. Each user identity 14a-14d may be a name, an occupation, or any other identifier for personnel in a critical communications environment. In general, the management system 10 may provide for enhanced communication techniques in a critical communication environment such as a medical environment, a security environment, or any other critical communications environment. By managing the at least one channel 16a-16c, the management system 10 may further provide for dynamic adjustments that allow for more effective messaging amongst the plurality of user identities 14a-14d. Further, the techniques employed by the management system 10 may limit unnecessary time consumption for non-essential messaging and promote organization for the turn-based communications. In the foregoing, various examples related to the operation of the management system 10 in a medical environment are presented, but such scenarios are exemplary and non-limiting.

The management system 10 may also include a monitoring module 17 that analyzes at least one communication attribute of the at least one channel 16a-16c. For example, the monitoring module 17 may be configured to receive and process audio data of the at least one channel 16a-16c. The communication attributes may be processed and/or analyzed by the monitoring module 17 to detect a level of importance, urgency, or value associated with the communication. In this way, the system 10 may prioritize communications based on the user and/or content communicated to limit unnecessary chatter and prioritize communications likely to include content that may be valuable or critical to facility operations and/or patient care. For example, the monitoring module 17 may monitor communications and detect attributes that indicate a level of importance, urgency, or value of the communication based on the content, origin (e.g., location, department, etc.), user profile (e.g., role, profession, training, etc.), association (e.g., manager, director, staff, etc.), or other attributes that may be associated with messages communicated among the communication devices 12.

In operation, the monitoring module 17 may utilize one or more processors (e.g., audio or signal processors) to analyze the attributes associated with the communications between or among the communication devices 12 to identify the attributes and distinguish or categorize the associated value or importance. In order to facilitate such operation, control circuitry 18 may be communicatively coupled with the monitoring module 17 and configured to execute one or more processing routines to evaluate the attributes of the communications and associate the communications with a corresponding value, importance, or priority. In some implementations, the processing routines may apply one or more learning algorithms (e.g., a machine learning algorithm, neural network, etc.) to determine a modification for the at least one channel 16a-16c. The modification may be any modification to the turn-based communications and/or the at least one channel 16a-16c to prioritize important communications over less important communications. For example, the modification may be an adjustment to membership of the at least one channel 16a-16c, an adjustment to allotted talking time for participants on the at least one channel 16a-16c, and/or an adjustment to the priority of one of the at least one channel 16a-16c over another of the at least one channel 16a-16c. In this way, the control circuitry 18 may determine the modification based on the at least one communication attribute and adjust a messaging feature or delivery priority of the at least one channel 16a-16c in response to the modification. The messaging feature or delivery priority includes at least one of a timer for push-to-talk (PTT) messaging, a membership of the user identity 14a-14d to the at least one channel 16a-16c, and a priority level for the at least one channel 16a-16c.

Still referring generally to FIGS. 1-6, the system 10 may analyze the content of the messaging on the at least one channel 16a-16c to prioritize participants and/or messages for any listener on the at least one channel 16a-16c. For example, if the content includes specific keywords related to a level of urgency or includes specific tones or verbiage corresponding to high-stress or urgent scenarios, the system 10 may promote those messages and/or users of the at least one channel 16a-16c to supersede other messages and/or users. For example, the use of particular trauma terminology (e.g., “bleeding,” incapacitated,” “arrest,” etc.) or expletives/cursing may be detected by the system 10. Accordingly, the urgent messaging may be detected based on the verbiage having a medical classification (e.g., descriptions of medical conditions, injuries, etc.) and/or exclamations having lay meaning (e.g., expletives, shouting, quick speech). In response to urgent messaging, the corresponding user identity 14a-14d may then be promoted from passive participation on the at least one channel 16a-16c to an administration level, or an administrator user, or such user may be allotted more or less talking time for the PTT technology. Further, cadence, verbal tone, inflection, or any other verbal qualities may be detected by the system 10 to cause promotion and/or supersession of those messages or the users of those messages over others. Some channels of the at least one channel 16a-16c may also, or alternatively, be promoted over other channels of the at least one channels 16a-16c based on the urgency or criticality of the messaging on the at least one channel 16a-16c. In this way, when a communication device 12 is operating in a scan mode (e.g., listening on several channels 16a-16c), during a conflicting messaging event in which multiple channels 16a-16c are in use, the system 10 may prioritize one channel 16a-16c over the other based on any of the communication attributes described herein.

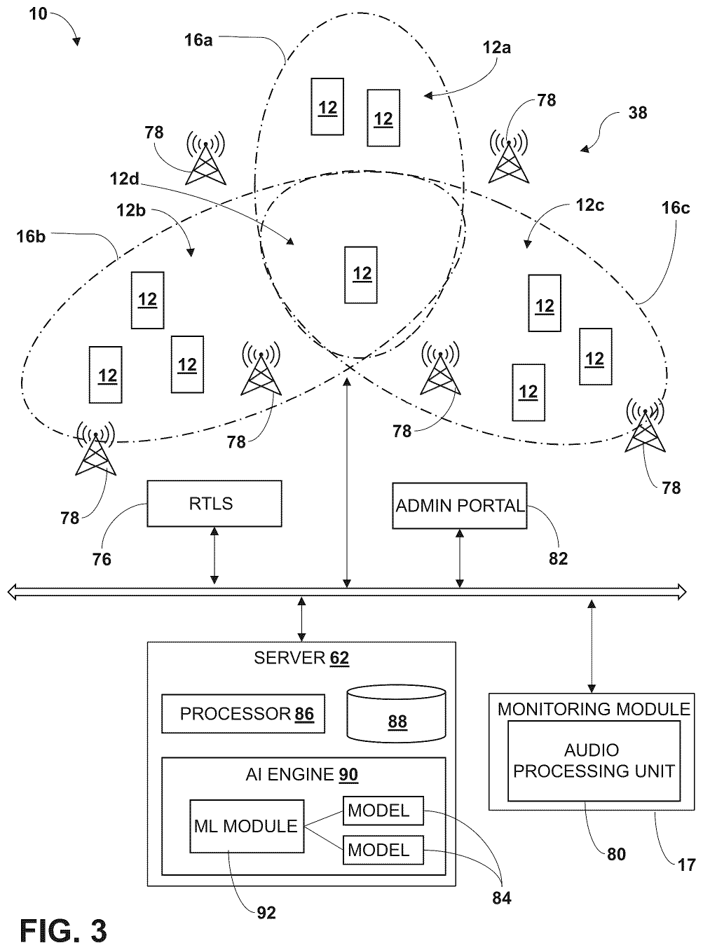

In some examples, the critical communication environment involves users having different operational roles, such as functions in an employment capacity. Accordingly, rules and/or privileges may apply to the communication device 12 assigned to one user having a first operational role, and these rules and/or privileges may be different than those applied to another user having a second, different, operational role. By way of example, when the environment is a hospital or other medical environment, the operational roles may correspond with various fields of study or various medical procedural categories (e.g., oncology, radiology, neurology, dermatology, obstetrics, surgery, critical care, emergency). The different roles may also relate to titles or tasks (e.g., nurse, doctor, charge nurse, surgeon, anesthesiologist). In this way, the turn-based communications of the present disclosure may be organized based on hierarchical structures and/or logical grouping, and such turn-based communications may be dynamically adjusted to optimize parameters/permissions and membership of the logical groupings. In some examples, the logical groupings correspond to the at least one channel 16a-16c. As will be described further in reference to FIGS. 3-6, each logical grouping, or channel 16a-16c, may include one or more administrators having the authority to mute or otherwise actively control membership and privileges of passive participants of the channel 16a-16c. These manual adjustments may be read by the control circuitry 18 to adjust future automatic adjustments performed by the control circuitry 18.

Referring now to FIG. 1, an exemplary communication device 12 of the plurality of communication devices 12 is a wearable communication device 19 that includes a housing 20 to be worn on, or by, a caregiver or other user. The housing 20 may include an attachment feature 22 that facilitates the use of the communication device 12 as being wearable. In some aspects, the attachment feature 22 includes a circlet, or loop, which may be configured to receive a lanyard, a clip, a band, or another connector configured to be worn around a body part, such as a wrist. The communication device 12 may also include a display 24 in the housing 20 for presenting messages, notifications, alerts, or any other communications to users of the plurality of communication devices 12. In various examples, the display 24 is configured as a user interface, such as a touch screen, to allow the user to control the communication device 12.

The communication device 12 includes a plurality of buttons 26, 28, 30 for controlling operation of the communication device 12. The plurality of buttons 26, 28, 30 includes a voice command button 26 that may be in the form of a tactile button. For example, when the communication device 12 is configured with push-to-talk (PTT) technology, the user may engage the voice command button 26 to communicate audio to other communication devices 12 of the plurality of communication devices 12. The plurality of buttons 26, 28, 30 may further include a channel change button 28 or knob that, when engaged by the user, causes the at least one channel 16a-16c to be changed on the communication device 12. Volume buttons 30 may be provided along a side 32 of the housing 20 for adjusting a volume of sound emitted from the communication device 12. While the voice command button 26 is illustrated on a front 34 of the communication device 12, and the help buttons are illustrated on the side 32 of the housing 20, the locations of each of the plurality of buttons 26, 28, 30 on the housing 20 may be different in other examples. For example, the voice command button 26 may be located on the side 32 of the housing 20 to allow the user to squeeze the housing 20 at the side 32 to hold the voice command button 26 down during voice transmission.

Notifications displayed on the display 24 or emitted through a speaker 36 of the communication device 12 may include various notifications intended for the caregiver(s) or other users. Notifications include messages (e.g., voice, sound, or text) from other devices of a network 38 (FIG. 3). The messages may include caller or call information, countdown timer messages (for example, countdown timers from which have reached a minimum threshold), global messages generated for pre-determined groups of staff (for example, all caregivers having a specific certification) on the at least one channel 16a-16c, automated messages from caregiver monitoring systems, call response messages (for example, information request calls and/or equipment request calls), and direct caregiver messages (for example, messages received from other caregivers). As will be described further, the notifications may be turn-based notifications on the at least one channel 16a-16c.

The speaker 36 and at least one microphone 40 are provided on the communication device 12 to enable communication amongst the plurality communication devices 12. For example, the user of the wearable communication device 19 may engage the voice command button 26 to speak to an array of microphones 40. Audio data is then captured and wirelessly communicated over the network 38 to the plurality of communication devices 12, which may present the audio data via the speaker 36 of another of the plurality of communication devices 12. The speaker 36 may be referred to as an output device for audio. In this way, audio signals may be shared by one communication device 12 amongst the plurality of communication devices 12 on a common channel 16a-16c or on different channels (e.g., when the communication device 12 is operating in the scan mode).

The scan mode may be employed for personnel in the critical communications environment (e.g., security, nurses, doctors, etc.) that work in multiple areas, or units, of the environment (e.g., a hospital) and serve as multi-unit employees. By providing a scan mode for the communication device 12, such personnel may monitor multiple channels 16a-16c for multiple areas or logical groupings and attend to which area is of highest priority. Accordingly, because the system 10 may dynamically adjust prioritization of one channel over another, the multi-unit employees may have increased efficiency and utilization. Stated differently, the system 10 will provide a scanning mode allowing user identities 14a-14d to receive traffic from several channels 16a-16c at the same time. Such mechanism will provide different logics to manage channel information collisions. As set forth in further detail herein, an artificial intelligence engine may be utilized to better promote some channels in specific scenarios.

Still referring to FIG. 1, the communication device 12 may include a camera 42 for recording images and/or video. In some examples, the turn-based communications include push-to-video (PTV) technology, and the communication device 12 is configured to share video captured via the camera 42 amongst the plurality of communication devices 12 on the at least one channel 16a-16c. The video data may be presented on the display 24 in lieu of or in addition to the audio data communicated amongst the plurality of communication devices 12. Accordingly, the turn-based communications described herein may be configured to send and/or receive various forms of data, including audio, video, text, images, or any other medium that may be communicated in a turn-based fashion. For example, turn-based communications may include any communication that limits communication to one user, or communication device 12, at a time and limits data transmitted by other communication devices 12 from being presented for that time (e.g., walkie-talkie functionality).

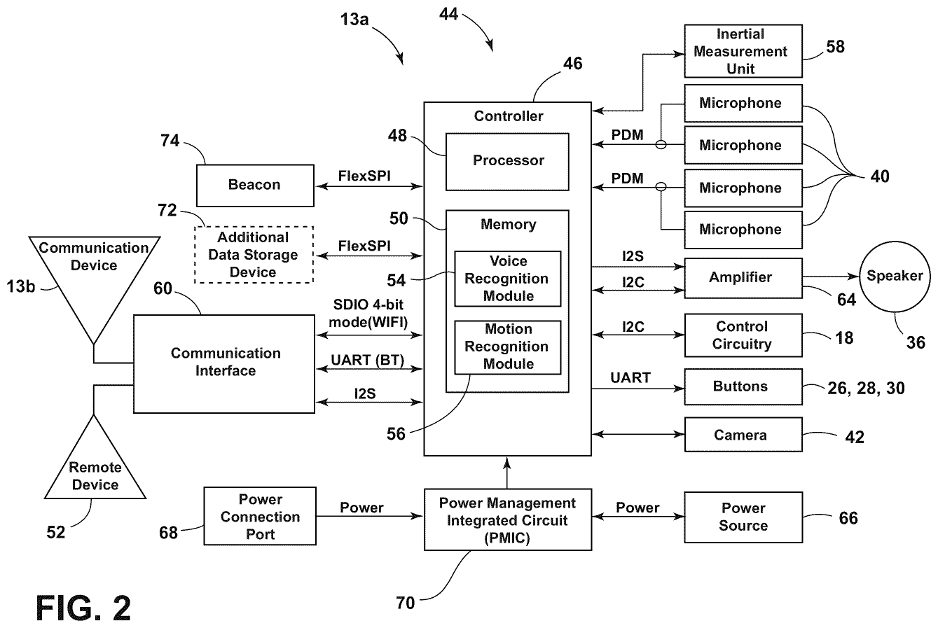

The communication device 12 described with respect to FIG. 1 may provide for enhanced user interaction in the critical communications environment where such interaction is time-sensitive. For example, by providing the interactive display 24 and the speaker 36, video and/or audio data may be presented to the user quickly and clearly. As will be described further with respect to FIG. 2 below, the components of the communication device 12 may be electrically coupled with hardware (e.g., processing and communication circuitry) and software to enhance user interaction with the components.

Referring now to FIG. 2, a block diagram of a communication system 44 for a first exemplary communication device 13a of the plurality of communication devices 12 is illustrated. The following exemplary circuits, devices, and accessories may be implemented to facilitate the operation of the system 10 as previously discussed and further described in reference to FIGS. 3-6. The communication system 44 includes a controller 46 that incorporates at least one processor 48 and a memory 50. The memory 50 stores instructions that, when executed by the processor 48, causes the controller 46 to transmit and receive information in the communication system 44. For example, the first exemplary communication device 13a may be in communication with a second exemplary communication device 13b of the plurality of communication devices 12 and/or at least one remote device 52. One, some, or each of the plurality communication devices 12 may include similar controllers 46, processors 48, memory 50, and other processing circuitry. In some examples, the communication device 12 includes more than one memory 50 and/or more than one processor 48. The controller 46 is generally configured for gathering inputs from the various electronic components, processing the inputs, and generating an output response to the input.

The processor 48 may include any type of processor capable of performing the functions described herein. The processor 48 may be embodied as a dual-core processor, a multi-core or multi-threaded processor, digital signal processor, microcontroller, or other processor or processing/controlling circuit with multiple processor cores or other independent processing units. The memory 50 may include any type of volatile or non-volatile memory (e.g., RAM, ROM, PSRAM) or data storage devices (e.g., hard disk drives, solid state drives, etc.) capable of performing the functions described herein. In operation, the memory 50 may store various data and software used during operation of the communication device 12 such as operating systems, applications, programs, libraries, databases, and drivers. The memory 50 includes a plurality of instructions that, when read by the processor 48, cause the processor 48 to perform the functions described herein.

The controller 46 may include a voice recognition module 54. The voice recognition module 54 may be configured to process voice inputs for authentication to recognize, or identify, the voice of one or more users associated with the communication devices 12 and/or the management system 10. Further, the controller 46 may include a motion recognition module 56. The motion recognition module 56 may be configured to process received motion data from an inertial measurement unit 58 at the communication device 12 and analyze it in reference to data stored in a motion recognition database to recognize or characterize the type of movement the communication device 12 is being subjected to. The voice recognition module 54 may be employed in tandem with audio processing of the monitoring module 17 to detect the verbiage and/or audio on the at least one channel 16a-16c to enhance audio processing for the system 10. The motion recognition module 56 may be employed to further assign urgency to the messaging or to promote or prioritize messaging from a communication device 12 undergoing quick or jostling movements. For example, the motion data may be communicated to the monitoring module 17, which may synthesize or merge such data with the audio data and/or communication signals to the server 62. In this way, the motion information may be used to adjust the modification calculation.

With continued reference to FIG. 2, the controllers 46 of the communication devices 13a, 13b are communicatively coupled with one another to establish a communication interface 60 therebetween. The controller 46 may also be configured to communicate with at least one server 62 (FIG. 3), which may include remote servers (e.g., cloud servers, Internet-connected databases, computers, mobile phones, etc.), via the communication interface 60. Specifically, other remote servers include, for example, nurse call computers, electronic medical records (EMR) computers, admission/discharge/transfer (ADT) computers, push-to-talk servers, location tracking server, and any other server.

The communication interface 60 allows communication to/from the exemplary communication device 12 on the network 38. The network 38 may incorporate one or more various communication technologies and associated protocols. Exemplary networks include wireless communication networks that may be operable with, for example, a Bluetooth® transceiver, a ZigBee® transceiver, a Wi-Fi transceiver, an IrDA transceiver, a Radio Frequency Identification (RFID) transceiver, or any other transmitting and receiving component for wireless communication protocol. Additionally or alternatively, the exemplary networks include 3G, 4G, 5G, local area networks (LAN), or wide area networks (WAN), including the Internet and other data communication services. Each of the controllers 46 may include circuitry configured for bidirectional wireless communication. Moreover, it is contemplated that the controllers 46 may communicate by any suitable technology for exchanging data. In a non-limiting example, the controller 46 of each communication device 12 may communicate over the communication interface 60 using internet protocol (IP). For example, the IP may include Voice-over-IP (VOIP). In another non-limiting example, the controllers 46 may communicate over the communication interface 60 via radio frequency (RF) signals. In either technology, each of the controllers 46 may include a single transceiver, or, alternatively, separate transmitters and receivers, that are configured to operate on the at least one channel 16a-16c. As will be described further in reference to FIGS. 3-6, the at least one channel 16a-16c may each be associated with a particular RF range/setting or particular IP settings depending on the communication scheme implemented on the network 38.

Still referring to FIG. 2, the speaker 36 of the communication device 12 is configured to convert an electromagnetic wave input from the processor 48 into an output, such as a sound wave (e.g., audio). In specific implementations, the speaker 36 includes a frequency range from approximately 500 Hz to approximately 3.75 kHz. A peak speaker 36 volume may include 85 dB SPL at 10 cm. An amplifier 64 may communicatively interpose with the controller 46 and the speaker 36 to amplify output of the speaker 36. The controller 46 may further be configured to control operation of the camera 42, which may include turning the camera 42 on or off (e.g., activating and deactivating) and recording (e.g., storing in memory 50) video data received by the camera 42.

The communication system 44 may include the inertial measurement unit 58 (e.g., accelerometer and/or gyroscope, magnetometer, etc.). The inertial measurement unit 58 may be configured to detect an acceleration and direction of motion associated with a wearer (e.g., caregiver). Therefore, the processor 48 of the controller 46 may be configured to detect abrupt movements of the communication device 12, which may correspond to a running, flailing, or falling condition of the user. In addition to tracking and detecting abrupt movements, the inertial measurement unit 58 may additionally detect one or more gestures of the user. For example, the gestures may include intentional waving motions, swiping movements, shaking, circular (e.g., clockwise, counterclockwise), rising, falling, or various movements of the communication device 12 in connection with the user. Moreover, the processor 48 of the communication device 12 may analyze and interpret abrupt movements and gestures as a command, or notification.

With continued reference to FIG. 2, the communication device 12 includes a power source 66, such as a battery, configured to provide power to the various electronic components of the communication device 12. The battery may be re-chargeable and/or replaceable. The communication device 12 may include a power communication port 68, such as a Universal Serial Bus (USB) port, for wired charging of the power source 66 and/or wired communication with the communication circuit. A power management integrated circuit (PMIC 70) may electrically interpose the power source 66 and the power communication port 68 to regulate power storage in the power source 66.

As previously described, the operating routines and software associated with the communication device 12 may access the memory 50. In some cases, additional data storage devices 72 may be incorporated in the communication device 12 configured for short-term or long-term storage of data such as, for example, memory devices and circuits, memory cards, hard disk drives, solid-state drives, or other data storage devices 72. The additional data storage device 72 may include a plurality of the voice command databases, each having a plurality of voice commands specific to a caregiver type (e.g., role). For example, the commands may include “administer medication,” “CPR,” “change bed,” etc. As previously discussed, separate voice command databases may be accessible for doctors, nurses, or caregivers having specific caregiver identifications. Other voice command databases are contemplated. For example, a housekeeper voice command database may be provided that is specific to a housekeeper.

A beacon 74 (e.g., RFID, ultra-wideband [UWB] transmitter, etc.) may be integrated within each of the plurality of communication devices 12. The beacons 74 are configured to send signals over the communication interface 60. In this way, other communication devices 12 or another remote device 52 over the communication interface 60 may retrieve locating information from a real-time locating system (RTLS) 76 for use by the processor 48 of the communication device 12. The management system 10 may locate the beacons 74 positioned within a predetermined range (e.g., a particular region or ward) and analyze the credentials associated with the communication devices 12 corresponding to those beacons 74. A map module accessible by the processor 48 may store data regarding the layout of the health care facility, which may include geographical coordinates. For example, the processor 48 may correlate a coordinate of a beacon 74 with a coordinate associated with a position stored within the map module. In this way, the management system 10 may infer, or determine, modification based further on the location of one or more of the plurality of communication devices 12, as will be described further in reference to FIG. 3.

With continued reference to FIG. 2, various aspects related to audio processing components will now be described. The microphones 40 are configured to detect sound signals (e.g., voice commands from a user) and send an output signal to the processor 48. In some examples, an effective range of the microphones 40 may include at least 10 meters. In this way, communication device 12 is configured for far-field sound, or speech, detection. The controller 46 controls operation of the microphones 40. Operation of the microphones 40 may include turning the microphones 40 on or off (e.g., activating and deactivating) and recording (e.g., storing in memory 50) audio data received by the microphones 40. In the same way, sound arriving at one or more microphones 40 may include audibly distinct noise characteristics from sound arriving at other microphones 40, which may be based at least partially on an orientation of the communication device 12 relative to a speaker 36. The microphones 40 provide the characteristic data to the processor 48 as inputs, which may be utilized in downstream decisions of an algorithm to minimize noise and maximize sound intelligibility. For example, the microphones 40 may output one or more time stamps indicative of an arrival time of a sound wave. In another example, the microphones 40 may provide the audibly distinct noise characteristics as inputs to the processor 48.

The processor 48 may include full-duplex voice processing software for digital signal processing (DSP) of the sounds detected by the microphones 40. The processor 48 may determine a noise floor, or the level of background noise (e.g., any signal other than the signal(s) being monitored) and remove specific frequencies caused by the background noise to minimize, or neutralize, the background noise. Moreover, the microphones 40 may be tuned to minimize the background noise in care settings, such as echoes and beeping noises originating from devices within the care setting (e.g., medical equipment). The processor 48 may also analyze three-directional information, including determining a direction that audio is originating from, which may be used for downstream decisions. In this way, the communication device 12 may extract sound sources within an operation range of the microphones 40, such as within a patient room or surgical suite. The audio may arrive at one or more microphones 40 prior to other microphones 40 due to a spatial arrangement (e.g., geometry) of the array of microphones 40. The location of the sound sources (e.g., speaking caregivers, operating equipment) may be inferred by using the time of arrival from the sources to microphones 40 in the array and the distances defined by the array. It will also be understood that the communication device 12 may utilize audio alerts or non-audio alerts, such as haptic alerts, which may include vibrations.

Based on the output signals from the microphones 40 to the processor 48, the processor 48 may transmit a signal over the communication interface 60 indicative of a voice message. As will be discussed in greater detail below, the communication device 12 may be configured to process the output signals from the microphones 40 and authenticate, or recognize, the voice of one or more caregivers by encoding phonetic information and/or nonverbal vocalizations (e.g., laughter, cries, screams, grunts). In one example, the processor 48 reviews the distinct noise characteristics to distinguish between and, ultimately, deduce which caregiver is speaking or vocalizing. In another example, the processor 48 reviews the distinct noise characteristics to distinguish between and, ultimately, deduce a type of person (e.g., female, male, infant, toddler), a person's biosocial profile, and/or a corresponding emotion (e.g., excited, happy, neutral, aggressive, fearful, and pain) the person is communicating. Audibly distinct noise characteristics may include, but are not limited to, tone, pitch, volume, quality (e.g., timbre), and the like.

The management system 10 may also identify devices/equipment that is in operation within a range of the microphones 40 when the communication device 12 is in the active listening mode. For example, the communication device 12 may identify incoming sounds as those of an infusion pump or a blood oxygen alert system but is not limited to such. Additional examples of devices/equipment located in the care facility include hospital beds and mattresses, syringe pumps, defibrillators, anesthesia machines, electrocardiogram machines, vital sign monitors, ultrasound machines, ventilators, fetal heart monitoring equipment, deep vein thrombosis equipment, suction apparatuses, oxygen concentrators, intracranial pressure monitors, feeding pumps/tubes, Hemedex® monitors, electroencephalography machines, etc. The communication device 12 may initiate an action to adjust settings (e.g., a volume of the speaker 36) of the device 12, provide alerts (e.g., sound or text) to one or more communication devices 12 (e.g., to the display 24 or speaker 36) in response to identifying a device that is in operation.

Referring now to FIG. 3, the network 38 may provide communication amongst the plurality of communication devices 12, the server 62, and other modules described below. The network 38 may include one or more repeaters 78, or routers, in the critical communications environment to boost coverage of the network 38. An individual communication device 12 may adjust between the plurality of channels 16a-16c to listen to activity on and/or communicate a message to a particular channel 16a, 16b, or 16c. In the illustrated example, the plurality of channels 16a-16c includes a first channel 16a, a second channel 16b, and a third channel 16c. The plurality of communication devices 12 includes a first set of communication devices 12a on the first channel 16a, a second set of communication devices 12b on the second channel 16b, and a third set of communication devices 12c on the third channel 16c. In this example, a multi-channel communication device 12d is part of each of the first, second, and third channels 16a-16c, while the remainder of the first, second, and third sets of communication devices 12a-12c are limited to the respective first, second, and third channel 16a-16c. Although only one multi-channel device 12d is illustrated in the present example, the subscription, or enrollment, of each communication device 12 may be dynamically changed by the system 10, such that any combination of channel subscriptions for the sets of communication devices 12a-12c may be employed. Accordingly, the multi-channel communication device 12d may communicate with each of the first, second, and third channels 16a-16c. In some examples, each of the communication devices 12 is equipped with multi-channel functionality, and each of the communication devices 12 may be controlled by the control circuitry 18 to join channels 16a-16c, leave channels 16a-16c, or be selected as part of a new channel. Thus, the channel participation may be adjusted dynamically based on several factors described in reference to the foregoing figures.

With continued reference to FIG. 3, the monitoring module 17 may be in communication with the plurality of communication devices 12 via the network 38. The monitoring module 17 may include an audio processing unit 80 for detecting the at least one communication attribute of the channel. For example, the at least one attribute of the at least one channel 16a-16c may include one or more attributes, such as a level of a usage, a level of non-usage, content on a particular channel (e.g., keywords, helpfulness), a level of urgency, or any other communication attribute that the control circuitry 18 may determine is beneficial to monitor. For example, the monitoring module 17 may adjust or focus detection of one or more particular communication attributes selected by the control circuitry 18 based on a level of utility determined by the control circuitry 18. In some examples, the audio processing unit 80 is configured to detect keywords, voice inflections, or any other verbal indication that may be processed via one or more machine-learning models 84 trained to modify the turn-based communications on the one or more channels 16a-16c.

In operation, the audio processing unit 80 may process the audio data to produce text information (e.g., speech-to-text technology). Following processing, the audio processing unit 80 may then evaluate the text information using keyword matching or contextual interpretation. For example, the audio processing unit 80 may employ analog-to-digital converters to isolate vibrations in sound waves and correlate such waves to syllables and words. The text may further be refined based on contextual clues. For example, the audio processing unit 80 may employ neural networks trained based on medical terminology, hospital lingo, or any other colloquialism typically used in a critical communications environment. The terminology used in the turn-based communications may be weighted based on urgency, utility, or other communication attribute determined by the control circuitry 18 in order to determine the level of priority for the user, channel, or message.

In some examples, the control circuitry 18 is configured to map, or classify, the at least one communication attribute to a level of criticality or urgency. Based on the level of urgency, the control circuitry 18 may determine the modification for the at least one channel 16a-16c. The modification may be any adjustment or modifier to the communication that adjusts the priority of messaging, users, or channels 16a-16c. Accordingly, the modification may be a signal or a variable that is adjusted by the control circuitry 18 to push users off of a channel 16a-16c, join users to a channel 16a-16c, change roles of the users on a channel, change a transmission time for users, or change the priority of channels 16a-16c scanned by a user. For example, if there is a high level of urgency in messaging from one user on a channel 16a-16c, the control circuitry 18 may modify the role of that user to be an administrator on the channel. Additionally, or alternatively, the control circuitry 18 may modify a usage time for the user (e.g., increase usage time) based on the determined utility of that user's messaging. Additionally, or alternatively, the control circuitry 18 may modify the priority of the plurality of channels 16a-16c to promote the channel 16a-16c that the user is on in response to the level of urgency or utility of the messaging from that user. Table 1 below represents an exemplary weight assignment for some of the plurality of communication attributes for the turn-based communications.

TABLE 1
Exemplary Attribute Mapping to Criticality Weight

| Attributes | Criticality Weight (0-10) |
|---|---|
| Inflection/tone | 4 |
| Meaning/Content | 8 |
| Context | 8 |
| Role | 6 |
| Proximity | 9 |
| Availability | 10 |
| Department | 5 |
| Duration of Use | 5 |

In reference to Table 1 above, based on the overall weighted score of the message (e.g., a sum criticality value), the control circuitry 18 may determine the modification for the at least one channel 16a-16c. For example, the machine learning algorithm may output the sum criticality value exceeding a pre-defined threshold. Based on the sum criticality value, the control circuitry 18 may adjust the delivery priority or messaging feature of the at least one channel 16a-16c. As will be described further herein, if the adjustment, or a proposed adjustment, from the control circuitry 18 is approved, disapproved, rejected or unmade by an administrator or manager of the turn-based communications, such change is received as feedback to the machine learning algorithm. In response to the feedback, the machine learning algorithm may adjust the criticality weights to produce more accurate urgency-level estimations.

By way of example, the control circuitry 18 may assign a first set of weighted criticality values to a first message relayed to the server 62 by the audio processing unit 80. The first message may result in an adjustment to the priority of a user, channel 16a-16c, or communication device 12, based on the first set of weighted criticality values. Upon feedback from manual adjustments (e.g., supervisor feedback, manual joining or leaving of channels 16a-16c, or any other modification feedback), the machine learning algorithm may adjust the weights to a second set of weighted criticality values. If a message similar to the first message is passed through the second set of weighted criticality values, no adjustment or a different adjustment, may be determined by the control circuitry 18 in response to the different weight values.

The communication attributes and weights demonstrated and described in reference to Table 1 are exemplary and non-limiting. For example, the speed of the verbiage in the messages, the number of different individuals heard on a common message, the temporal proximity to events (e.g., surgeries, patient intakes, etc.), or any other communication attribute may be detected by the system 10 and weighted to optimize the turn-based communications. Further, each channel 16a-16c may have a different set of weights based on the logical grouping priorities of the group. For example, if one channel 16a-16c is dedicated to security staff for a hospital, the inflection/tone may have a higher weight than another channel 16a-16c dedicated to nursing staff for a specific medical unit (e.g., emergency room). In this way, a plurality of prioritization approaches may be applied to the turn-based communications to produce personalized priority management by the system 10.

In some examples, specific keywords may be prioritized over others based on a level of lethality, criticality, and/or urgency. For example, patient status terms such as bleeding, hemorrhage, high, low, indications of patient health status, types of injuries (e.g., head wound, laceration, etc.) may be prioritized over other terms, such as “discharged,” “wash,” “visitor,” or other lower-priority terminology. Further, patient vital sign descriptions and associated meanings may be detected by the audio processing unit 80 and classified by the control circuitry 18. The vital sign descriptor terms may include “blood pressure,” “pulse,” and other such terms may be used in reference to values or numbers. For example, the terms “blood pressure” followed by “87 over 42” may be detected by the control circuitry 18 and classified as critical (e.g., a high sum criticality value). Conversely, detecting the terms “blood pressure” followed by “120 over 65” may be classified as not critical. In response to the classification, the control circuitry 18 may adjust the priority of messaging, user identities 14a-14d, and/or the at least one channel 16a-16c. Thus, the meaning of terms may be inferred by and classified by the control circuitry 18. Accordingly, the context of the communication may be detected by the control circuitry 18 and/or the monitoring module 17 to limit false or unnecessary priority categorizations by the management system 10.

In general, the audio processing unit 80 may incorporate any of the features previously described regarding audio processing performed on each of the plurality of communication devices 12. For example, the audio processing unit 80 may be configured to recognize the voice of one or more caregivers by encoding phonetic information and/or nonverbal vocalizations (e.g., laughter, cries, screams, grunts). The audio processing unit 80 may review the distinct noise characteristics to distinguish between and, ultimately, deduce which caregiver is speaking or vocalizing. The audio processing unit 80 may review the distinct noise characteristics to distinguish between and, ultimately, deduce a type of person (e.g., female, male, infant, toddler), a person's biosocial profile, and/or a corresponding emotion (e.g., excited, happy, neutral, aggressive, fearful, and pain) the person is communicating. Audibly distinct noise characteristics may include, but are not limited to, tone, pitch, volume, quality (e.g., timbre), and the like. Accordingly, the tasks performed by the processor 48 of the communication device 12 may be performed alternatively by the audio processing unit 80. In the present example, the audio processing unit 80 is employed to detect these various verbal qualities and identify keywords using voice recognition to classify the turn-based communications on the at least one channel 16a-16c.

With continued reference to FIG. 3, an administrator portal 82 may be provided on the network 38 to allow users to interface with data monitored by the monitoring module 17 and stored by the server 62. For example, the administrator portal 82 may include a display and/or user input devices for interacting with data presented at the display. The administrator portal 82 may include a web-based interface to allow users to execute diagnostic reports related to the at least one communication attribute monitored by the monitoring module 17. As will be described further herein, one or more machine learning models 84 employed by the management system 10 may recommend modifications that will be presented in the report, and a user, such as a dispatcher or other manager of communication on the network 38, may enable the suggested modification. Additionally or alternatively, the modification may be implemented, and the report may include an indication that the modification was implemented. The dispatcher may then enter a command to undo or accept the modification. Such feedback may allow the machine learning models 84 to undergo supervised learning to enhance modifications or proposed modifications to the turn-based communications.

Referring now to the particular aspects of the server 62 illustrated in FIG. 3, the server 62 may include a processing device 86 and a memory, such as a database 88, in communication with the processing device 86. The database 88 stores instructions that, when executed by the processing device 86, cause the processing device 86 to communicate signals to monitor and/or control the turn-based communications on the network 38. The processing device 86 may include any type of processor previously described with respect to the processor 48 of the communication system 44 previously described. The processing device 86 receives data from the monitoring module 17, such as keyword information for each user of a channel 16a-16c and levels of usage or non-usage at a user-specific level and communicates that information to an artificial intelligence (AI) engine 90 on the server 62. The AI engine 90 may process the information captured by the monitoring module 17 in one or more of the machine learning models 84 trained to adjust the turn-based communications based on the information received. For example, the AI engine 90 may have a machine learning module 92 through which the machine learning models 84 are generated.

The management system 10 may be configured to enroll new users and process intake information of the new users. For example, the processing device 86 of the server 62 may communicate a signal to store new user information in the database 88 in response to a new user joining the critical communications environment. For example, if a new doctor joins the hospital, the field of study or practice of the doctor may input be to the database 88 to allow the server 62 to choose channel membership for the doctor based on other users having common features. In general, the user intake information may be stored in the database 88 to allow the control circuitry 18 to sort and assign the user identities 14a-14d into channels 16a-16c. Alternatively, or additionally, selected channels 16a-16c may be presented to the new user (e.g., at the display 24) based on the control circuitry 18 correlating the new user with other user identities on the network 38. In this way, the management system 10 may recommend one or more channels 16a-16c in response to logically grouping the intake information with the identification information of existing user identities 14a-14d in the management system 10.

The employees may be linked to one or more care or service groups during or after enrollment into the management system 10. The care groups associated with each caregiver may be assigned and stored in the directory, which may map the care groups for communication and alert processes. The care groups may have corresponding channels 16a-16c assigned by the control circuitry 18. The care groups may be defined based on the specific skills, certifications, security clearance, training, credentials, etc., for each caregiver. Based on the association of each of the caregivers to each of the care groups, communications (e.g., voice commands) that are associated with each of the caregiver's respective skills may be communicated, or broadcasted, to the communication device 12 that is addressed and assigned to one or more qualified caregivers. In this way, communications over the network 38 may be routed to communication devices 12 assigned to caregivers who are qualified, or skilled, to adequately respond to a particular call or message.

In general, control circuitry 18 may refer to any device or arrangements of devices that control adjustments to the turn-based communications of the management system 10. For example, the control circuitry 18 may include the server 62 (e.g., the processing device 86, the database 88, the AI engine 90, the machine learning module 92, the machine learning models 84), the processor 48 and memory 50 of one or more of the plurality of communication devices 12, any other control device that may perform any part of the adjustment, or any other control circuitry 18 on the network 38.

With continued reference to FIG. 3, the management system 10 may employ the RTLS 76 in combination with the control circuitry 18 to allow the processing algorithms (e.g., the machine learning algorithms) of the server 62 to generate the modification based further on location data of one or more of the communication devices 12. In general, the relative location of the communication devices 12 in the medical environment may influence the priority or supersession of messages, user roles, and/or channels 16a-16c. For example, the proximity of a communication device 12 relative to higher-priority locations in the critical communications environment, such as regions, departments, patient rooms, or any other area in the critical communications environment may be determined by the RTLS 76 and factored into the modification determination. Continuing with this example, the map module previously described may be accessed by the control circuitry 18 to provide further optimization of the priority modification.

By way of example, the RTLS 76 may detect that an otherwise low-priority user identity 14a-14d or low-priority messaging is being used, but such use is communicated from an operating room or an emergency room. In such an example, the location, as detected by the RTLS 76 and beacons 74 of the communication devices 12 transmitting the low-priority messaging, causes the control circuitry 18 to promote this message or user based on the location of the transmitting communication device 12. In another example, one of the channels 16a-16c may be promoted over another of the channels based on a concentration of messaging originating from communication devices 12 in an operating room, a critical care unit, or any other higher-priority region in the medical environment. In this way, when a communication device 12 is operating in the scan mode, the priority for the channels 16a-16c being scanned may adjusted live based on the modification generated by the machine learning algorithm, as well as the proximity of the transmitting devices to higher-priority regions.

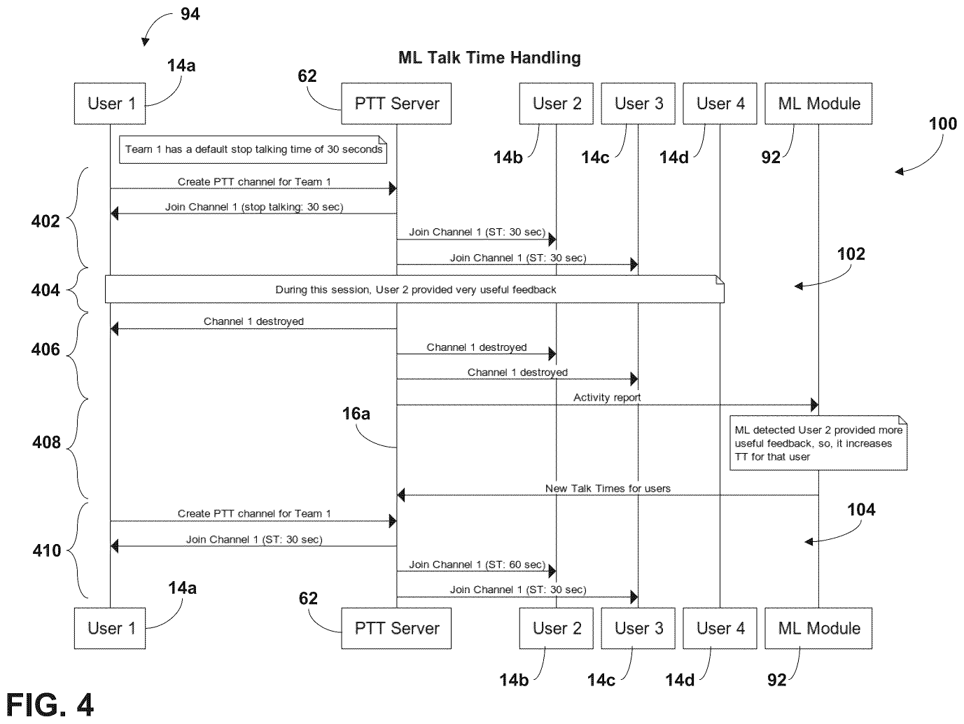

Referring now to FIGS. 4-6, three exemplary adjustment processes 94, 96, 98 for modifying the turn-based communications of the management system 10 are demonstrated. In each process, a messaging feature, or delivery priority, of the at least one channel 16a-16c is adjusted by the control circuitry 18 in response to the modification determined by the machine learning algorithm executed by the control circuitry 18. The modification, as previously described, may be an adjustment to a value of a variable or signal of the system 10 that modifies the priority or promotion of messages, users, channels 16a-16c, or any other characteristic of the at least one channel 16a-16c. The messaging feature may be adjusted by modifying the IP settings for the communication device 12 dynamically, with each IP address or set of IP settings being assigned with specified rules and privileges (e.g., administrator, participant). In other examples, frequency ranges for RF communications may be dynamically modified in a range of between, for example, 30 to 300 megahertz (MHz). The messaging feature may refer to a timing of the communication handling on a channel 16a-16c, a membership of one or more of the user identities 14a-14d on a channel 16a-16c, or a priority level for the at least one channel 16a-16c, as previously described. It is contemplated that the messaging feature may include other attributes of the at least one channel 16a-16c in some examples, such as any listening or transmission permissions for users on a channel 16a-16c, a scan duration (e.g., an amount of time one channel 16a-16c is monitored before toggling to another channel 16a-16c to be monitored), or any other property of the at least one channel 16a-16c.

The three exemplary adjustment processes 94, 96, 98 may be configured to adjust properties of the channels 16a-16c, such as subscription status of the user identities 14a-14d, timing assigned to the user identities 14a-14d, etc. For example, the channels 16a-16c may be adjusted by the server 62 to correlate to specific users and/or communication devices 12. Because the channels 16a-16c may be generated and sorted by modifying IP or RF settings dynamically, a communication device 12 may be programmed to adjust subscription status to different channels 16a-16c depending on the day or time. Because the communication devices 12 may be shared across shifts, they may also have membership to different channels depending on when the communication devices 12 are in use. The user identities 14a-14d may refer to names or other indicators of an identity of the user on the at least one channel 16a-16c. The user identities 14a-14d may be digital profiles that are assigned when the communication devices 12 change use (e.g., at shift change). In other examples, the communication devices 12 are assigned to individuals and are not shared.

With particular reference to FIG. 4, the management system 10 may be employed to adjust a duration of a transmission for a given user identity 14a-14d based on a first session 100 of a first channel 16a in a first adjustment process 94. A session may refer to a period of time, such as a work shift over several hours, in which the channel 16a has a team (e.g., a common set of user identities 14a-14d) on the channel 16a. Because the team may change on a weekly, daily, or hourly basis or less, each instance of the team occurring may serve as another session. In this way, instances of each session may be tracked and parameters of the session may be optimized based on the quality of each preceding session. In the present example, the first session 100 is on a first channel 16a and includes a first user identity 14a, a second user identity 14b, a third user identity 14c, and a fourth user identity 14d. In a first instance 102 of the first session 100, the monitoring module 17 may monitor, using the audio processing unit 80, the data communicated within the channel. The monitoring module 17 may, for example, transcribe or otherwise synthesize the data into a format readable by the control circuitry 18, and communicate the data to the server 62. The data may include image data, video data, or, as in the present example, audio data that may be processed in the machine learning algorithm to estimate or determine a modification for a second instance 104 of the first session 100. For example, in the first instance 102 of the first session 100, a duration for a transmission from one of the first-fourth user identities 14a-14d may be the same for each of the first-fourth user identities 14a-14d (e.g., 30 seconds). In this example, the management system 10 provides for dynamic adjustment to the duration for each of the plurality of user identities 14a-14d individually based on interaction within the first team.

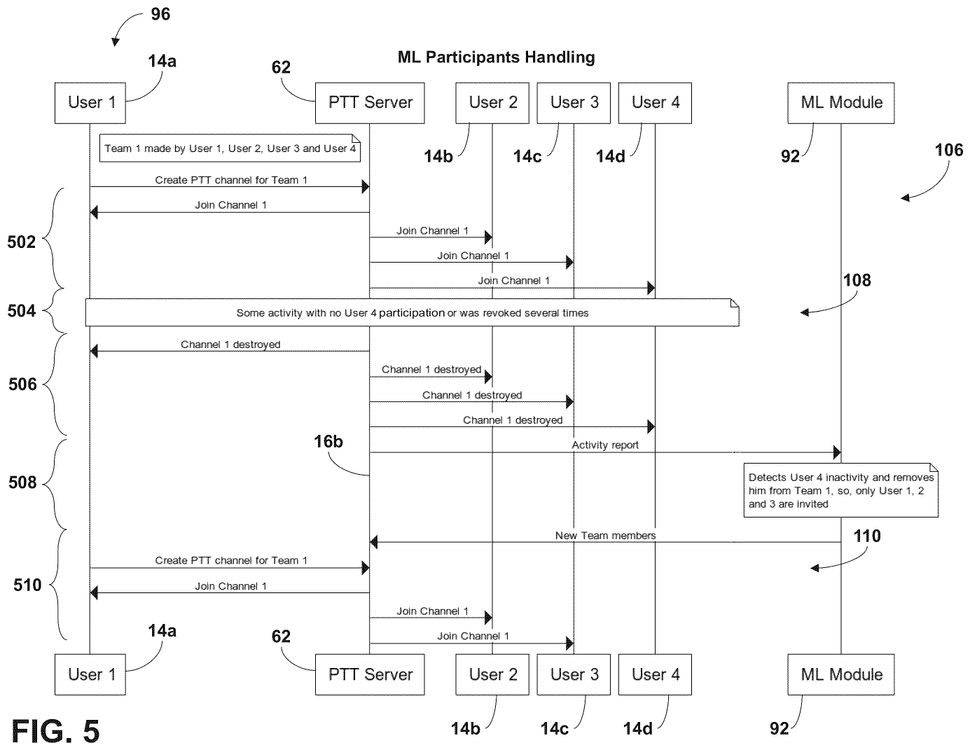

Following creation of the first session 100 on the first channel 16a, the first team is formed by adding the first, second, and third user identities 14a-14c for the first channel 16a at step 402. For example, the control circuitry 18 may form the first team based on occupation, relative location (e.g., proximity to one another), department, names of the users, employment status, user selection, and/or another factor. In some examples that will be described with respect to FIG. 5, the membership for the first team may be determined by the control circuitry 18 based on content of the communication during the first instance 102 of the first session 100. In these examples, user identities 14a-14d may be added or revoked based on utility determined by the control circuitry 18.

At step 404, the turn-based communications of the first channel 16a during the first instance 102 of the first session 100 are monitored by the monitoring module 17 and analyzed by the control circuitry 18. For example, the server 62 and the monitoring module 17 may cooperate with one another to or independently differentiate between useful communications and irrelevant or non-useful communications. For example, “small-talk” or audio not related to a designated use for the channel may be monitored using the audio processing module, and the processing device 86 may distinguish between related and unrelated information. At step 406, the first team is disbanded (e.g., at a shift-change) and a report is compiled by the server 62 and processed in the machine learning algorithm. At this step, the report may also be accessed via the administrator portal 82 previously described with respect to FIG. 3. Although the data gathered during the first instance 102 is processed following disbandment of the team, in some examples, the audio data is processed live by the server 62, or periodically (e.g., every 5 minutes, 10 minutes, 30 minutes) in the machine learning algorithm to actively adjust the at least one messaging feature. In such an example, further instances (e.g., the second instance 104) may refer to periods following an adjustment.

With continued reference to FIG. 4, at step 408, the one or more machine learning models 84 monitor the interaction based on participation of each of the user identities 14a-14d in the first instance 102 of the session and adjust the transmission time based on the interaction. For example, the participation may be a time of use on the first channel 16a, a utility of transmissions when using the first channel 16a, or any other parameter regarding participation on the first channel 16a during the first instance 102. At step 410, upon formation of the first team in a second instance 104 of the first session 100, the duration for talking time, or transmission time, for each of the user identities 14a-14d is updated with a new time. In the present example, the one or more machine learning models 84 determined that the second user identity 14b should receive a greater duration for each turn-based communication based on the useful feedback provided by the second user identity 14b in the first instance 102.

By way of example, if the first team presented in FIG. 4 is for a part of a neurology unit in a hospital, the monitoring module 17 may process the audio communicated during the first instance 102. The control circuitry 18 may then detect keywords related to neurology and/or patient room numbers for patients with neurological trauma and score communications containing those keywords higher than other communications transmitted during the first instance 102 of the first session 100. Additionally, or alternatively, location data may be synthesized with or separately read by the server 62, and the control circuitry 18 may adjust each score based on movement of the communication devices 12 corresponding to the user identities 14a-14d, relative location of the communication devices 12 to each other, or any other inference based on location data. Further, video or image data transmitted in the first channel 16a may be utilized by the control circuitry 18 to score the participation of each user identity 14a-14d. Based on the score, the designated talking time, or duration of transmission, may be adjusted for the second instance 104 or other future instances. In the present example, the second user identity 14b may have had a much higher score than the other user identities 14a, 14b, and 14d during the first instance 102 and, as a result, the second user identity 14b received a 60-second maximum duration instead of a default 30-second duration for the other user identities 14a, 14b, and 14d.

Referring now more particularly to FIG. 5, a second adjustment process 96 implemented by the management system 10 is configured to modify which user identities 14a-14d are members of the second channel 16b. Similar to the steps of the first adjustment process 94, following creation of a second session 106 on a second channel 16b, a first team is formed by adding each of the first, second, third, and fourth user identities 14a-14d to a first instance 108 of the second session 106 for the channel at step 502. For example, the control circuitry 18 may form the first team based on occupation, relative location (e.g., proximity to one another), department, names of the users, employment status, user selection, or another other factor. At step 504, the turn-based communications of the second channel 16b during the first instance 108 of the second session 106 are monitored by the monitoring module 17 and analyzed by the server 62, similar to step 404 of the first adjustment process 94. In this example, the server 62 and the monitoring module 17 may corporate with one another to or independently monitor the usage for each user identity 14a-14d during the first instance 108 of the second session 106. For example, if the fourth user identity 14d has little to no participation on the second channel 16b for the first instance 108, or an administrator for this session (e.g., the first user) has revoked transmission authority for the fourth user identity 14d several times, such information may be collected and stored in the database 88. This feedback may be used by the machine learning algorithm to recommend modification of or modify the turn-based communications.

At step 506, the first team is disbanded (e.g., at a shift-change) and a report is compiled by the server 62 and processed in the machine learning algorithm. At this step, the report may also be accessed via the administrator portal 82. Although the data gathered during the first instance 108 is processed following disbandment of the first team, in some examples, the audio data and revocation information is processed live by the server 62, or periodically (e.g., every 5 minutes, 10 minutes, 30 minutes) in the machine learning algorithm to actively adjust the at least one messaging feature. In such an example, further instances (e.g., a second instance 110) may refer to periods following an adjustment.

With continued reference to FIG. 5, at step 508, the machine learning models 84 classify the interaction based on participation of each user identity 14a-14d in the first instance 108 of the second session 106 and adjust the membership of the second channel 16b based on the classification. For example, the participation may be a time of use on the channel, a number of revocations of transmission privileges that occurred for each user identity 14a-14d during the first instance 108, or any other undesirable participation feature. For example, an administrator of the second channel 16b may revoke transmissions of a participant in the second session 106 multiple times. At step 510, upon formation of a second team in the second instance 110 of the second session 106, the membership to the second channel 16b is adjusted by modifying membership on the first team (e.g., changing the number of participants). In the present example, the machine learning models 84 determined that the fourth user identity 14d should not be included on the second channel 16b with the first, second, and third user identities 14a-14c based on previous usage. In some examples, disinvitation of the fourth user identity 14d is based on detection of the fourth user identity 14d “monopolizing” the second channel 16b.

The adjustments to membership and privileges on the channel 16a, 16b as described with respect to the first and second processes 94, 96 may be employed simultaneously with one another or separate from one another. For example, the modification for the common channel 16a, 16b may include a termination of the membership for one user identity 14a-14d and an adjustment to a time of use by another user identity 14a-14d retained on a common channel 16a, 16b. The modification may also or alternatively adjust a role for one or more of the user identities 14a-14d. For example, a passive participant may be promoted or assigned as an administrator for the common channel 16a, 16b based on usage. Similarly, the administrator may be demoted or assigned as a passive participant for the channel based on usage. These determinations may also be based on feedback to the machine learning models 84, real-time location data from the RTLS 76, or other communication attributes other than usage, such as the number of channels a user identity 14a-14b is part of. For example, a nurse anesthetist may be needed in a surgical environment and in a child delivery environment. Accordingly, the nurse anesthetist may be assigned to multiple channels (e.g., a channel 16a-16c for delivery and a channel for surgery) and may therefore be assigned a passive participant role due to complexity of managing two channels.

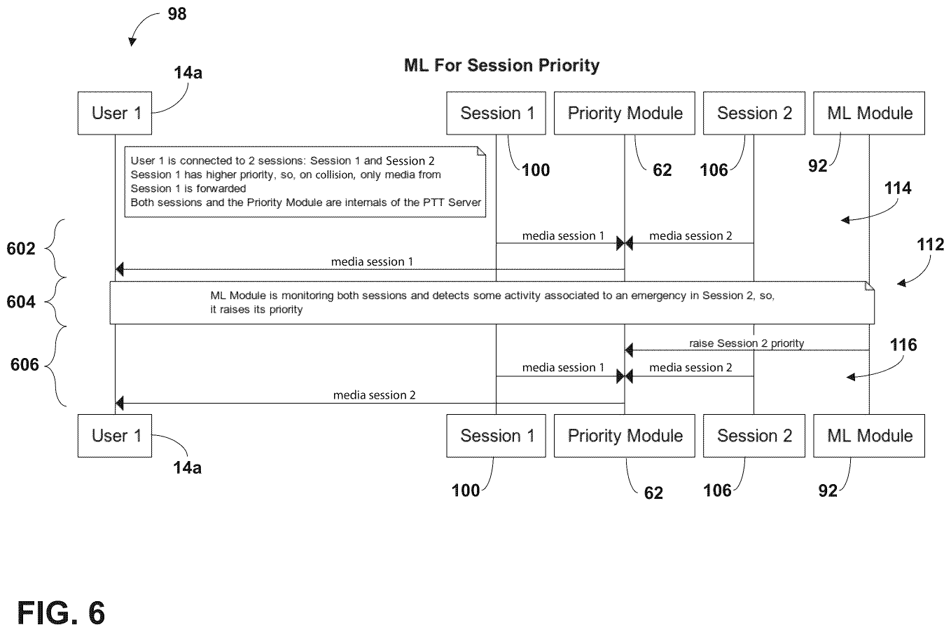

Referring now to FIG. 6, a third adjustment process 98 implemented by the management system 10 is configured to modify a priority level for each channel 16a-16c being monitored by a common user identity 14a (e.g., the first user identity 14a). At step 602, a first instance 114 of the monitoring session 112 is formed with the first and second sessions 100, 106 being monitored. In this example, the common user identity 14a is connected to multiple sessions 100, 106 in the first instance 114 of a monitoring session 112 via the scan function of the communication device 12. In the first instance 114, the first session 100 of the first channel 16a being monitored by the common user identity 14a is assigned with a higher priority level than the second session 106 of the second channel 16b being monitored by the common user identity 14a. Accordingly, when transmissions are communicated in each of the first and second sessions 100, 106 simultaneously, the management system 10 may cause the speaker 36 on the communication device 12 assigned to the common user identity 14a to output the session having the highest priority level (e.g., the first session 100).

At step 604, the one or more machine learning models 84 determines the priority level for each session 100, 106 based on a level of urgency detected by the control circuitry 18. For example, the server 62 may classify the verbal data captured by the monitoring module 17 and processed in the audio processing unit 80. In some examples, classification of the level of urgency is performed by the one or more machine learning models 84 trained based on audio data of a medical environment or other critical-communication environment. For example, the AI engine 90 may have trained the one or more machine learning models 84 to classify alarms, voice inflections, verbal speed, voice volume, cadence, or other verbal tones to detect urgency or an emergency. In some examples, the audio processing unit 80 processes the audio data to classify it as urgent, non-urgent, or a value therebetween. For example, the level of urgency may be on a scale (e.g., 1-100).

At step 606, a second instance 116 of the monitoring session 112 is initiated based on adjustments to the priority level of the multiple sessions 100, 106. Adjustment from the first instance 114 to the second instance 116 of the monitoring session 112 may result in a channel-priority adjustment. Thus, the first instance 114 may have a first ranking of channels 16a-16c, and the second instance 116 may have a second ranking of channels 16a-16c different than the first ranking. Upon detection of one or more of factors previously described (e.g., location of communication devices 12, words used on the channels 16a, 16b, etc.), the system 10 adjusts the priorities of channels 16a, 16b for the second instance 116. In the present example, the control circuitry 18 may have determined that the second channel 16b had greater urgency than the first channel 16a during the first instance 114 of the monitoring session 112. As a result, the priority level of the second channel 16b was raised to be greater than the priority level of the first channel 16a. As previously described with respect to the first and second processes 94, 96, in some examples, the data is processed live by the server 62, or once periodically (e.g., every 5 minutes, 10 minutes, 30 minutes) in the machine learning algorithm to actively adjust the at least one messaging feature (e.g., the priority level).

Any of the first, second, or third adjustment processes 94, 96, 98 described above may be employed using audio data, video data, image data, location data, motion data, or any other information trackable on the network 38 in any combination (e.g., location data detected by the RTLS 76). For example, the one or more machine learning models 84 may be trained to adjust the at least one messaging feature based on location, image data captured by the camera 42 on each of the plurality of communication devices 12, previous team habits, or any other factors related to optimizing turn-based communications within a common channel 16a-16c or for monitoring multiple channels 16a-16c. Further, the adjustment processes 94, 96, 98 carried out by the management system 10 may be carried out simultaneously, such that talk time, membership, and priority levels may be actively optimized.

According to one aspect of the present disclosure, a system for managing turn-based audio communications includes a user identity assignable to a communication device of a plurality of communication devices, the communication device configured to communicate the turn-based audio communications on at least one channel. The system includes a monitoring module that monitors at least one communication attribute of the at least one channel. Control circuitry is communicatively coupled with the monitoring module and configured to determine a modification for the at least one channel based on the at least one communication attribute and adjust a messaging feature of the at least one channel in response to the modification. The messaging feature includes at least one of a timer for push-to-talk (PTT) messaging, a membership of the user identity to the at least one channel, and a priority level for the at least one channel.

According to another aspect of the present disclosure, the control circuitry is configured to execute a machine learning algorithm to determine the modification for the at least one channel.

According to another aspect of the present disclosure, the user identity includes at least one of a name and an occupation.

According to another aspect of the present disclosure the user identity is a role. The role is one of an administrator and a participant on the at least one channel.

According to another aspect of the present disclosure, the at least one channel includes at least two channels each having the membership, the membership including the administrator and the participant.

According to another aspect of the present disclosure, the system includes a wireless network communicatively coupling the communication device with the monitoring module. The control circuitry is further configured to assign the communication device to the at least one channel via the wireless network.

According to another aspect of the present disclosure, the at least one channel includes a first channel having a first radio frequency setting and a second channel having a second radio frequency setting different than the first radio frequency setting.

According to another aspect of the present disclosure, the at least one channel includes a first channel having first internet protocol settings and a second channel having second internet protocol settings different than the first internet protocol settings.

According to another aspect of the present disclosure, the first channel is communicatively isolated from the second channel.

According to another aspect of the present disclosure, the system includes a server incorporating at least a portion of the control circuitry. The server includes an artificial intelligence engine configured to generate at least one machine learning model trained to determine the modification.

According to another aspect of the present disclosure, the control circuitry is further configured to receive a feedback signal in response to the adjustment to the messaging feature and process the feedback signal in the at least one machine learning model.

According to another aspect of the present disclosure, the control circuitry is further configured to modify the machine learning algorithm using the at least one machine learning model.

According to another aspect of the present disclosure, the feedback signal is an indication from an administrator of the at least one channel indicating an approval of the adjustment.

According to another aspect of the present disclosure, a system for managing turn-based audio communications includes at least one user identity assignable to a communication device configured to communicate the turn-based audio communications on at least one channel. The at least one user identity has membership on a common channel of the at least one channel. A monitoring module monitors at least one communication attribute of the common channel. Control circuitry is communicatively coupled with the monitoring module and configured to detect interaction within the membership in a session on the common channel, classify the interaction based on participation of the at least one user identity in the session, determine a modification for the common channel based on classification of the interaction, and adjust the membership of the common channel in response to the modification.

According to another aspect of the present disclosure, the control circuitry is further configured to execute a machine learning algorithm to determine the modification for the common channel.

According to another aspect of the present disclosure, the modification is a termination of the membership of the at least one user identity.

According to another aspect of the present disclosure, the participation includes a time of use by the at least one user identity on the common channel.

According to another aspect of the present disclosure, the at least one of the user identity includes an administrator and a participant. The participation includes a number of revocations for the participant by the administrator during the session.

According to another aspect of the present disclosure, the control circuitry is further configured to adjust a duration for a turn for the turn-based communication based on the participation.

According to another aspect of the present disclosure, the system includes an audio processing unit communicatively coupled with the control circuitry and configured to detect keywords communicated on the at least one channel.

According to another aspect of the present disclosure, the participation includes the keywords. The control circuitry is configured to adjust the duration for the turn based on the keywords.

According to another aspect of the present disclosure, the system includes a database comprising identification information for at least one new user. The control circuitry is further configured to modify the common channel to add the at least one new user to the common channel based on the identification information.

According to another aspect of the present disclosure, the control circuitry is configured to compare the identification information to the keywords to determine addition of the at least one new user.

According to another aspect of the present disclosure, the identification information includes an occupation and a field of experience of the new user.

According to yet another aspect of the present disclosure, a system for managing turn-based audio communications includes at least two channels over which the turn-based communications are exchanged among a plurality of communication devices. The at least two channels have at least one priority level. The system includes an audio output device configured to selectively output the turn-based audio communications of a channel of the plurality of channels having the highest priority level. A monitoring module monitors at least one communication attribute of the plurality of channels. The at least one communication attribute includes audio of verbal content of the turn-based audio communications. An audio processing unit is communicatively coupled with the monitoring module and configured to detect the verbal content based on the audio for each of the at least two channels. Control circuitry communicatively couples with the monitoring module and the audio processing unit. The control circuitry is configured to classify the verbal content of the at least two channels with a level of urgency, determine a modification for the at least one priority level of the at least two channels based on the level of urgency of each of the at least two channels, and adjust the at least one priority level of the at least two channels in response to the modification.

According to another aspect of the present disclosure, the control circuitry is configured to execute a machine learning algorithm to determine the modification for the at least one priority level of each of the plurality of channels.

According to another aspect of the present disclosure, the system includes a real-time locating system configured to track a location of at least one of the plurality of communication devices. The determining of the modification is further based on the location of each of the at least one communication device.

According to yet another aspect of the present disclosure, a method for managing turn-based audio communications includes monitoring at least one communication attribute of at least one channel over which the turn-based audio communications are exchanged among a plurality of communication devices, determining a modification for the at least one channel based on the at least one communication attribute, and adjusting a messaging feature of the at least one channel in response to the modification, the messaging feature including at least one of a timer for push-to-talk (PTT) messaging, a membership of the user identity to the at least one channel, and a priority level for the at least one channel.

According to yet another aspect of the present disclosure, determining the modification for the at least one channel is performed via execution of a machine learning algorithm.

According to yet another aspect of the present disclosure, the method includes assigning a user identity to a communication device of the plurality of communication devices. The user identity includes at least one of a name and an occupation.

According to yet another aspect of the present disclosure, the user identity is a role. The role is one of an administrator and a participant on the at least one channel.

According to yet another aspect of the present disclosure, the at least one channel includes at least two channels each having the membership, the membership including the administrator and the participant.

According to yet another aspect of the present disclosure, the method includes assigning the communication device to the at least one channel via a wireless network.

According to yet another aspect of the present disclosure, the at least one channel includes a first channel having a first radio frequency setting and a second channel having a second radio frequency setting different than the first radio frequency setting.

According to yet another aspect of the present disclosure, the at least one channel includes a first channel having first internet protocol settings and a second channel having second internet protocol settings different than the first internet protocol settings.

According to yet another aspect of the present disclosure, the first channel is communicatively isolated from the second channel.

According to yet another aspect of the present disclosure, the method includes generating, via an artificial intelligence engine, at least one machine learning model trained to determine the modification.

According to yet another aspect of the present disclosure, the method includes receiving a feedback signal in response to the adjustment to the messaging feature and processing the feedback signal in the at least one machine learning model.

According to yet another aspect of the present disclosure, the method includes modifying the machine learning algorithm using the at least one machine learning model.

According to yet another aspect of the present disclosure, the feedback signal is an indication from an administrator of the at least one channel indicating an approval of the adjustment.

According to yet another aspect of the present disclosure, the method includes tracking a location at least one of the plurality of communication devices. Determining the modification is further based on the location of the at least one communication device.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A system for managing turn-based audio communications, the system comprising:
a user identity assignable to a communication device of a plurality of communication devices, the communication device configured to communicate the turn-based audio communications on at least one channel;
a monitoring module that monitors at least one communication attribute of the at least one channel; and
control circuitry communicatively coupled with the monitoring module and configured to:
determine a modification for the at least one channel based on the at least one communication attribute; and
adjust a messaging feature of the at least one channel in response to the modification, the messaging feature including at least one of a timer for push-to-talk (PTT) messaging, a membership of the user identity to the at least one channel, and a priority level for the at least one channel.

2. The system of claim 1, wherein the control circuitry is configured to execute a machine learning algorithm to determine the modification for the at least one channel.

3. The system of claim 1, wherein the user identity includes at least one of a name and an occupation.

4. The system of claim 1, wherein the user identity is a role, wherein the role is one of an administrator and a participant on the at least one channel.

5. The system of claim 4, wherein the at least one channel includes at least two channels each having the membership, the membership including the administrator and the participant.

6. The system of claim 1, further comprising:
a wireless network communicatively coupling the communication device with the monitoring module, wherein the control circuitry is further configured to assign the communication device to the at least one channel via the wireless network.

7. The system of claim 1, wherein the at least one channel includes a first channel having a first radio frequency setting and a second channel having a second radio frequency setting different than the first radio frequency setting.

8. The system of claim 1, wherein the at least one channel includes a first channel having first internet protocol settings and a second channel having second internet protocol settings different than the first internet protocol settings.

9. The system of claim 2, further comprising:
a server incorporating at least a portion of the control circuitry, the server including an artificial intelligence engine configured to generate at least one machine learning model trained to determine the modification.

10. The system of claim 9, wherein the control circuitry is further configured to:
receive a feedback signal in response to the adjustment to the messaging feature; and
process the feedback signal in the at least one machine learning model.

11. A system for managing turn-based audio communications for use with at least one communication device configured to communicate on at least one channel, the system comprising:
at least one user identity assignable to said at least one communication device, wherein the at least one user identity has membership on a common channel of said at least one channel;
a monitoring module that monitors at least one communication attribute of the common channel; and
control circuitry communicatively coupled with the monitoring module and configured to:
detect interaction within the membership in a session on the common channel;
classify the interaction based on participation of the at least one user identity in the session;
determine a modification for the common channel based on classification of the interaction; and
adjust the membership of the common channel in response to the modification.

12. The system of claim 11, wherein the control circuitry is further configured to:
execute a machine learning algorithm to determine the modification for the common channel.

13. The system of claim 11, wherein the modification is a termination of the membership of the at least one user identity.

14. The system of claim 13, wherein the participation includes a time of use by the at least one user identity on the common channel.

15. The system of claim 14, wherein the at least one of the user identity includes an administrator and a participant, wherein the participation includes a number of revocations for the participant by the administrator during the session.

16. A method for managing turn-based audio communications, the method comprising:
monitoring at least one communication attribute of at least one channel over which said turn-based audio communications are exchanged among a plurality of communication devices;
determining a modification for the at least one channel based on the at least one communication attribute; and
adjusting a messaging feature of the at least one channel in response to the modification, the messaging feature including at least one of a timer for push-to-talk (PTT) messaging, a membership of a user identity to the at least one channel, and a priority level for the at least one channel.

17. The method of claim 16, further comprising:
assigning a user identity to a communication device of the plurality of communication devices, wherein the user identity includes at least one of a name and an occupation.

18. The method of claim 16, wherein the user identity is a role, wherein the role is one of an administrator and a participant on the at least one channel.

19. The method of claim 18, further comprising:
assigning the communication device to the at least one channel via a wireless network.

20. The method of claim 16, further comprising:
receiving a feedback signal in response to the adjustment to the messaging feature; and
processing the feedback signal in at least one machine learning model.
